(19) United States
(12) Patent Application Publication
(10) Pub. No.: US 2008/0185755 A1
(43) Pub. Date: Aug. 7, 2008

(54) Method of Manufacturing a semi-Structural Panel

(76) Inventors: Todd Deaville, Brampton (CA); Steven J. Mori, Aurora (CA)

Correspondence Address: MAGNA INTERNATIONAL, INC., 337 MAGNA DRIVE, AURORA, ON, L4G-7K1, omitted

(21) Appl. No.: 11/815,679

(22) PCT Filed: Feb. 9, 2006
(86) PCT No.: PCT/CA06/00183

§ 371 Date: Aug. 7, 2007

(51) Int. Cl. B29C 45/14

(52) U.S. Cl. 264/257

(57) ABSTRACT

A method for manufacturing a motor vehicle panel from a melt, including a thermoplastic material and long glass fibers, and a film utilizes a mold assembly including a stationary mold, a movable mold, and a mold cavity defined therebetween. The method of manufacturing includes the steps of: securing the film to the movable mold; moving the movable mold towards the stationary mold; introducing the melt into the mold cavity when the mold cavity is at a predetermined thickness; and closing the movable mold against the stationary mold to compress the melt and form the motor vehicle panel with the film molded thereto.

### FIELD OF THE INVENTION

The invention relates to a method of manufacturing a motor vehicle panel. More particularly, the invention relates to a method of manufacturing a motor vehicle panel having a Class A surface finish via injection-compression molding.

### DESCRIPTION OF RELATED ART

There is a significant market for motor vehicle finishes, particularly finishes for exterior panels. The most commonplace material utilized for such finished exterior panels is painted steel. The painted steel panels are formed by stamping steel sheets into discrete parts followed by assembly and painting. There are, however, certain disadvantages associated with such painted steel finishes. Specifically, the production process for the painted steel panels is highly polluting and consumes a great deal of energy. In addition, the resulting panels add significant weight to the motor vehicle, which in turn further increases energy consumption. Moreover, a significant capital investment and tooling cost is required before the production process for the painted steel panels even begins.

In light of the foregoing problems with using painted steel, thermoplastic composites have become an attractive alternative. In many cases, the manufacture of thermoplastic composites with finishes is more cost-effective than the production of painted steel panels. In addition, thermoplastic composites are lighter in weight and have more environment-friendly finishes than their painted steel counterparts. Further, thermoplastic composites allow for more styling options and a variety of decorative finishes.

Injection molding and compression molding are both well-known processes that utilize long fibers, either glass or carbon, to reinforce the thermoplastic composite in order to provide a panel with improved physical properties, including strength, stiffness, and dimensional stability. But while strength and stiffness are gained, the surface finish is degraded during these molding processes. As a result, a Class A surface finish that is suitable for the automotive industry is not achieved.

Therefore, there is a need for a method of manufacturing a panel from a thermoplastic composite reinforced by long glass fibers that has a Class A surface finish.

### SUMMARY OF THE INVENTION

According to one aspect of the invention, a method of manufacturing a panel from a melt, including thermoplastic material and long glass fibers, and a film utilizes a mold assembly including a stationary mold, a movable mold, and a mold cavity defined therebetween. The method of manufacturing the panel includes the steps of: securing the film to the movable mold; moving the movable mold towards the stationary mold; introducing the melt into the mold cavity when the mold cavity is at a predetermined thickness; and closing the movable mold against the stationary mold to compress the melt and form the motor vehicle panel with the film molded thereto.

According to another aspect of the invention, a method of manufacturing a panel from a melt, including thermoplastic material and long glass fibers, and a film utilizes a mold assembly including a stationary mold, a movable mold, and a mold cavity defined therebetween. The method of manufacturing the panel includes the steps of: securing the film to the movable mold; mixing the thermoplastic material with the long glass fibers to form the melt; moving the movable mold towards the stationary mold; introducing the melt into the mold cavity when the mold cavity is at a predetermined thickness; and closing the movable mold against the stationary mold to compress the melt and form the motor vehicle panel with the film molded thereto.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a side view of an inline compounder and injection unit for delivering melt to a horizontal mold assembly;

FIG. 2 is a side view of the mold assembly including a stop pad and a shear edge seal-off;

FIG. 3 is a cross-sectional view of a motor vehicle panel formed in the mold assembly; and

FIG. 4 is a side view of an inline compounder and injection unit for delivering melt to a vertical mold assembly.

### DETAILED DESCRIPTION OF THE PREFERRED EMBODIMENT

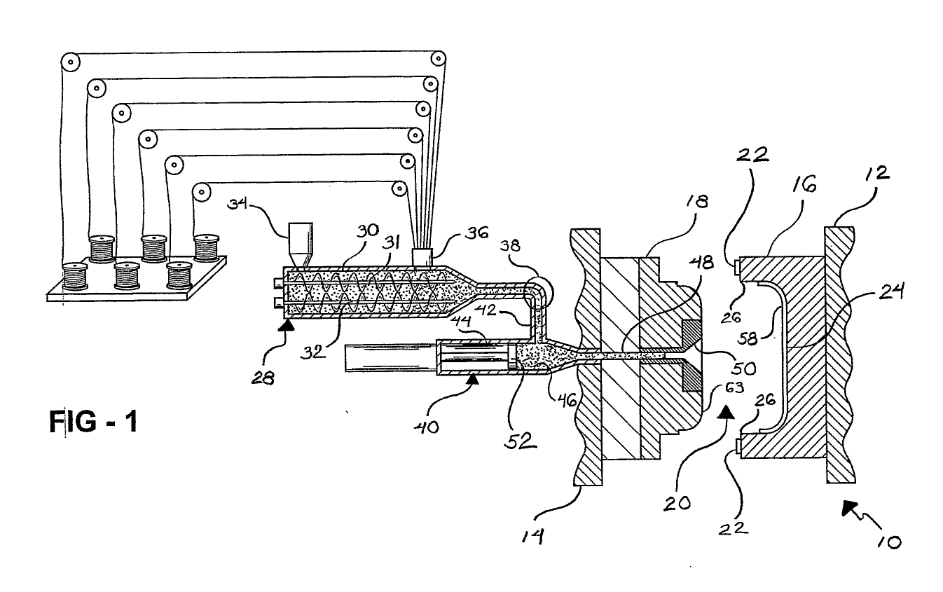

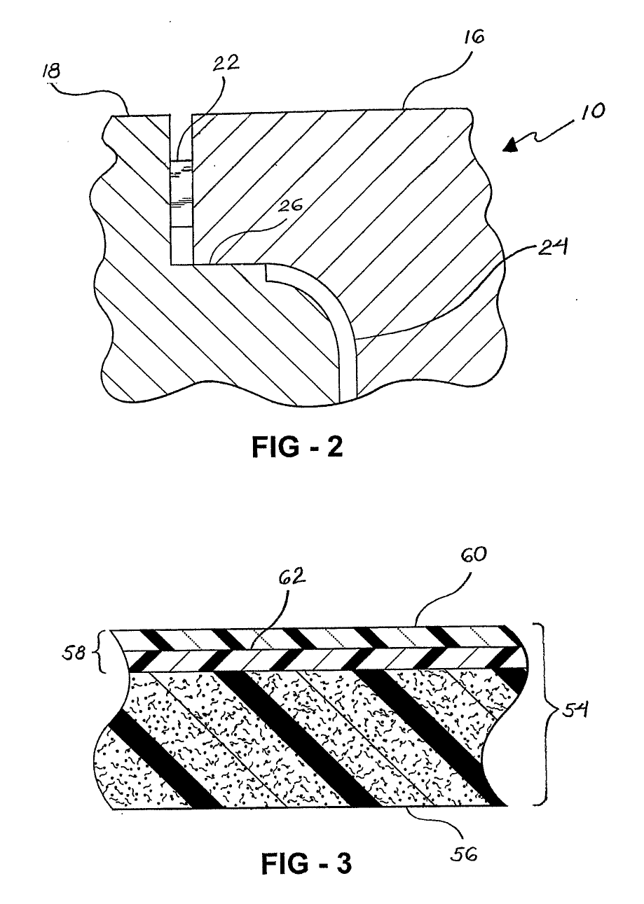

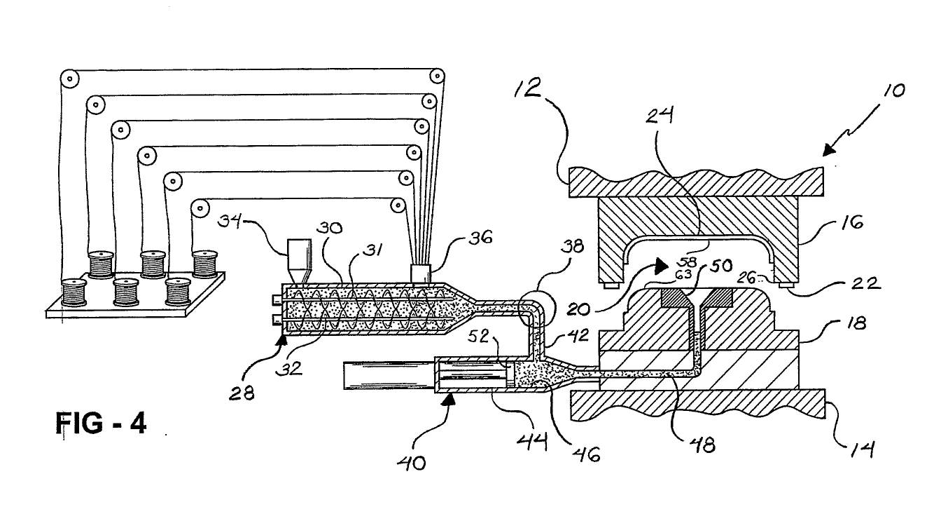

Referring to FIGS. 1 and 2, a mold assembly, generally shown at 10, includes a movable platen 12 and a fixed platen 14. The movable platen 12 moves relative to the fixed platen 14 by any of numerous methods known to those skilled in the art. A movable mold 16 is fixedly mounted to the movable platen 12 and a stationary mold 18 is fixedly mounted to the fixed platen 14. Therefore, the movable mold 16 is able to move relative to the stationary mold 18. In an exemplary embodiment, the mold assembly 10 is a horizontal mold in which the movable mold 16 moves in a horizontal plane. It is, however, appreciated that the mold assembly 10 may be a vertical mold, as shown in FIG. 4, in which the movable mold 16 moves in a vertical plane.

The movable 16 and stationary 18 molds define a mold cavity 20 therebetween. A stop pad 22 is fixedly secured to one of the movable 16 and stationary 18 molds to stop movement of the movable mold 16 towards the stationary mold 18 when the movable mold 16 is at a predetermined distance from the stationary mold 18. The size of the stop pad 22 may vary, which in turn allows for variation in the predetermined thickness of the mold cavity 20. The movable mold 16 includes a show surface 24 facing the inside of the mold cavity 20. A shear edge seal-off 26 is formed along the movable mold 16 adjacent the show surface 24 thereof and operates in the die draw direction.

Referring now to FIG. 1, an inline compounder, generally indicated at 28, is spaced apart from the mold assembly 10. The inline compounder 28 includes a barrel 30 for accommodating twin screws 31, 32. The twin screws 31, 32 run in the same direction and mesh with one another. A feed hopper 34 supplies a thermoplastic material in pellet form to the barrel 30, and a glass feeder 36 is positioned downstream of the feed hopper 34 to provide long glass fibers into the barrel 30. The inline compounder 28 melts the thermoplastic material and then mixes the thermoplastic material with the long glass fibers. A valve 38 regulates the flow of the resulting melt, including the thermoplastic material and the long glass fibers, exiting the inline compounder 28.

An injection unit, generally indicated at 40, is disposed between the inline compounder 28 and the mold assembly 10. The injection unit 40 includes a cylinder 44 having an anterior cylinder space 46. A channel 42 extends between the inline compounder 28 and the injection unit 40. The melt exiting the inline compounder 28 travels through the channel 42 and accumulates in the anterior cylinder space 46, which is connected to the mold cavity 20 of the mold assembly 10 by a manifold 48. A gate 50 selectively closes the manifold 48. The injection unit 40 also includes an injector or plunger 52. When the anterior cylinder space 46 is filled with a predetermined amount of the melt, the injector 52 is operated to inject the melt into the mold cavity 20 via the manifold 48 at a predetermined pressure.

The above-described mold assembly 10, inline compounder 28, and injection unit 40 are utilized to form a motor vehicle panel 54, generally shown in FIG. 3, from the thermoplastic material and long glass fibers. The panel 54 has a thickness of approximately 4-5 mm and may be any of numerous horizontal and semi-structural vertical motor vehicle panels including, but not limited to, a door panel, a hood, a roof panel, a decklid panel, and a liftgate panel.

The panel 54 includes a backing substrate 56, formed from the melt including the thermoplastic material and long glass fibers, molded to a film, generally indicated at 58. In a preferred embodiment, the thermoplastic material is polycarbonate. The long glass fibers are supplied in rovings that are fed through the glass feeder 36 to cutting elements on the twin screws 31, 32 prior to being mixed with the thermoplastic material. It is, however, appreciated that the long glass fibers may, in the alternative, be pre-chopped and supplied in bundles. Preferably, the long glass fibers have a length of approximately 0.5″ and account for approximately 10 to 40% of the weight or mass of the backing substrate 56. It is, however, appreciated that the length of the long glass fibers and the percentage weight of the long glass fibers may vary. The use of polycarbonate filled with long glass fibers allows the panel 54 to meet dimensional and high temperature requirements.

Any of a variety of additives may be added to the thermoplastic material and long glass fibers. Many of the additives increase the compatibility of the long glass fibers to the thermoplastic material. Some examples of additives include, but are not limited to, heat stabilizers, release agents, coupling agents, impact modifiers, colorants, and talc filler.

The film 58 includes a clear outer layer 60 and an inner layer 62 that is compatible with the backing substrate 56. The compatibility between the film 58 and the backing substrate 56 allows for a strong adhesion therebetween. One or more additional layers, such as a color layer (not shown) may be interposed between the clear outer 60 and inner 62 layers. It is appreciated that the inner layer 62 may be a color layer. The film 58, which has a thickness of approximately 0.8 mm, is secured to the movable mold 16 so that the clear outer layer 60 abuts the show surface 24 of the movable mold 16. In order to fit within the mold assembly 10, the film 58 must be trimmed prior to being secured to the movable mold 16. It is appreciated that the film 58 may be secured to the movable mold 16 in any of numerous ways. It is also contemplated that the film 58 may be secured to a show surface 63 of the stationary mold 18 with the gate 50 repositioned so as to allow introduction of the melt into the mold cavity 20.

The film 58 that is selected must provide the panel 54 with a Class A surface finish that is suitable for the automotive industry. Therefore, the film 58 must have a high-gloss and colored finish. There are numerous commercially available films that may be utilized. Preferably, a polycarbonate based film is utilized for the present invention.

In a method of manufacturing the panel 54, the film 58 is first secured to the movable mold 16 so that the clear outer layer 60 abuts the show surface 24. Thermoplastic material, preferably polycarbonate, is fed into the barrel 30 of the inline compounder 28 via the feed hopper 34, where it is melted and then mixed with long glass fibers, which are fed into the barrel 30 via the glass feeder 36. When the valve 38 is open, the resulting melt flows through the channel 42 and into the cylinder 44 of the injection unit 40. More specifically, the melt accumulates in the anterior cylinder space 46 of the cylinder 44. The movable mold 16 begins to move towards the stationary mold 18. When the mold cavity 20 is a predetermined thickness, the injector 52 injects the melt into the mold cavity 20 via the manifold 48 and open gate 50. The movable mold 16 closes against the stationary mold 18 to compress the melt and force the melt to fill all areas of the mold cavity 20. Once the stop pad 22 of the movable mold 16 abuts the stationary mold 18, movement of the movable mold 16 stops and the mold assembly 10 is closed. At this time, the shear edge seal-offs 26 seal the outer edges of the mold cavity 20 to prevent the melt from leaking out of the mold cavity 20. With the mold assembly 10 now closed, the backing substrate 56 is molded to the inner layer 60 of the film 58 in order to form the panel 54. The panel 54 is then removed from the mold assembly 10. Finally, any post-mold trimming on the panel 54 is conducted. The clear outer layer 62 of the film 58 provides the molded panel 54 with a class A surface finish that is suitable for the automotive industry.

The above-described injection-compression process avoids breaking up the long glass fibers due to low shear so that fiber length is maintained throughout. In addition, the injection-compression process provides more random glass fiber orientation than what would be achieved through injection molding. As a result, warp caused by shrink differentials are reduced.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

1. A method of manufacturing a motor vehicle panel from a melt, including thermoplastic material and long glass fibers, and a film utilizing a mold assembly including a stationary mold, a movable mold, and a mold cavity defined therebetween, the method comprising the steps of:
securing the film to one of the stationary and movable molds;
moving the movable mold towards the stationary mold;
introducing the melt into the mold cavity when the mold cavity is at a predetermined thickness; and
closing the movable mold against the stationary mold to compress the melt and form the motor vehicle panel with the film molded thereto.

2. A method as set forth in claim 1 wherein the step of closing the movable mold against the stationary mold to compress the melt and form the motor vehicle panel with the film molded thereto includes the step of forcing the melt into all areas of the mold cavity.

3. A method as set forth in claim 2 wherein the step of introducing the melt into the mold cavity when the mold cavity is at a predetermined thickness occurs simultaneous with the step of closing the movable mold to compress the melt and form the motor vehicle panel with the film molded thereto.

4. A method as set forth in claim 3 wherein the step of closing the movable mold against the stationary mold to compress the melt and form the motor vehicle panel with the film molded thereto includes the step of stopping the movable mold at a predetermined distance from the stationary mold.

5. A method as set forth in claim 4 including the step of sealing off edges of the mold cavity.

6. A method as set forth in claim 5 including the step of trimming the film to fit along one of the stationary and movable molds.

7. A method as set forth in claim 6 including the step of mixing the thermoplastic material with the long glass fibers to form the melt.

8. A method of manufacturing a motor vehicle panel from a melt, including thermoplastic material and long glass fibers, and a film utilizing a mold assembly including a stationary mold, a movable mold, and a mold cavity defined therebetween, the method comprising the steps of:
securing the film to one of the stationary and movable molds;
mixing the thermoplastic material with the long glass fibers to form the melt;
moving the movable mold against the stationary mold;
injecting the melt into the mold cavity when the movable mold is at a predetermined distance from the stationary mold; and
closing the movable mold against the stationary mold to compress the melt and form the motor vehicle panel with the film molded thereto.

9. A method as set forth in claim 8 including the step of sealing off the edges of the mold cavity.

10. A method as set forth in claim 9 wherein the step of closing the movable mold against the stationary mold to compress the melt and form the motor vehicle panel with the film molded thereto includes the step of stopping the movable mold at a predetermined distance from the stationary mold.

11. A method as set forth in claim 10 wherein the step of closing the movable mold against the stationary mold to compress the melt and form the motor vehicle panel with the film molded thereto includes the step of forcing the melt into all areas of the mold cavity.

12. A method as set forth in claim 11 wherein the step of introducing the melt into the mold cavity when the mold cavity is at a predetermined thickness occurs simultaneous with the step of closing the movable mold to compress the melt and form the motor vehicle panel with the film molded thereto.
